(19) United States
(12) Patent Application Publication
(10) Pub. No.: US 2026/0085528 A1
(43) Pub. Date: Mar. 26, 2026

(54) LASER WELDED TROWEL BLADE ASSEMBLY

(71) Applicant: Multiquip, Inc., Cypress, CA (US)

(72) Inventor: Tyler N. CLEMENTS, Highland Village, TX (US)

(73) Assignee: Multiquip, Inc., Cypress, CA (US)

(21) Appl. No.: 19/340,832

(22) Filed: Sep. 25, 2025

Related U.S. Application Data
(60) Provisional application No. 63/699,710, filed on Sep. 26, 2024.

(51) Int. Cl. E04F 21/16; B23K 9/02; B23K 101/20; E04F 21/24

(52) U.S. Cl. CPC E04F 21/161; B23K 9/02; E04F 21/245; B23K 2101/20

(57) ABSTRACT

A trowel blade assembly for use on a power trowel includes multiple blades, each having a top surface and a bottom surface, and a blade bar attached to the top surface by a laser weld. The blade is manufactured from unfinished sheet metal of trowel blade quality by a method that uses a laser for both cutting and welding the sheet metal. With the blade bar stabilized on the top surface of the blade, the laser weld is applied along the bottom surface of the blade in a single continuous weld, or as multiple non-continuous weld segments, in a path that is parallel to a longitudinal center of the blade bar.

### RELATED APPLICATIONS

This application claims priority to U.S. Provisional Application 63/699,710 filed Sep. 26, 2024, the contents of which are fully incorporated herein by reference.

### BACKGROUND OF THE INVENTION

### Field of the Invention

The present invention relates generally to power trowel machines, and, more particularly, to power trowel blade assemblies and methods for manufacturing a blade for such as assembly.

### Description of Related Art

Power trowels are well-known in the art. Power trowels are used in concrete finishing operations, typically on large-scale pours to allow an operator to finish vast areas of concrete quickly and efficiently. Power trowels come primarily in two varieties: walk-behind and ride-on. Power trowels utilize well-known floating and finishing techniques as the final steps for concrete slabs. Floating involves passing a flat tool, typically a float pan attached to the trowel blades, over and downward against a leveled slab of concrete to remove surface imperfections, flatten the surface, and compact the concrete to sink the aggregate and bring water to the surface. After the slab has been floated using the power trowel, an operator makes another pass with the float pan removed to finish the slab. During the finishing process, an operator will pitch the trowel blades, which rotate over the top surface of the slab. As the blades rotate, they continually scrape the top surface of the slab to fill in any low spots and remove surface imperfections. The pitch of the blades can be used to control speed and direction of movement in the ride-on power trowels.

Trowel blades are attached to power trowels through several subassemblies. Primarily, the trowel blade are attached to a blade bar, which provides the interface for connecting to the rotor of the power trowel machine. The manufacture of trowel blades, however, is complicated, expensive and time consuming. Typically, trowel blades are stamped out of coil sheet steel using large mechanical presses. The initial stamped blade is a thin sheet of steel shaped to the blade requirements. Depending on the quality of the stamping operation, the stamped blade may require additional finishing, such as grinding or sanding, to remove sharp edges or burrs resulting from the stamping process. The mechanical presses used in this operation require significant maintenance, which increases the per blade cost of manufacturing. In many trowel blade manufacturing operations, there is an entire department dedicated to the maintenance and repair of these mechanical presses.

With the blade shape formed, the next step requires rivet holes to be countersunk into the blade and corresponding rivet holes bored through a blade bar so the pieces can be assembled as one. With the rivet holes formed, a trained operator rivets the blade bar to the blade. In efficient operations, this process can take several minutes per blade and involve at least two operators: one to bore the rivet holes and one to rivet the pieces together. In less efficient operations, the time required to manufacture satisfactory trowel blade assemblies can significantly increase the per blade production costs.

The blade bar is attached to the trowel blade by welding, typically by laying the bead along the bottom edge of the blade bar, and this has been conventional practice in the industry for about the last 60 or 70 years. This practice, however, creates unwanted stress points that cause the blade under load to bend along the weld line. The resulting deformation of the trowel blade reduces its useful life and causes undesirable defects in a concrete surface being finished.

What is needed is a trowel blade assembly that can be expeditiously manufactured without creating unnecessary stress points in the blade under load.

### SUMMARY OF THE INVENTION

A trowel blade assembly configured for use on a power trowel machine includes one or more trowel blades. According to the present invention, each trowel blade in the assembly includes a top surface and a bottom surface, and a blade bar positioned on the top surface, wherein the blade bar is attached to the blade by a laser weld. The blade bar provides the interface for connecting the blade to the power trowel machine. The laser weld is applied along the bottom surface of the blade in a single continuous weld, or as multiple non-continuous weld segments, aligned in parallel to a longitudinal center of the blade bar. The laser weld extends through the bottom surface of the blade to weld a portion of the blade bar to the blade. The weld line formed by the laser weld may be coplanar with the bottom surface of the blade. The laser weld may applied using a laser stir welding technique.

The blade bar may include two or more screw holes defined in the blade bar and configured to engage a trowel arm of a power trowel. Such an embodiment may utilize multiple non-continuous weld segments, each lying between an adjacent pair of screw holes.

The edge of the trowel blade may be finished by smoothing one or more edges of the blade using a laser, for example, by forming an outer bullnose, half-bullnose, or demi-bullnose lasered edge. According to the invention, the laser used to finish the blade edge may be the same laser that is used to weld the blade to the blade bar, in a separate manufacturing step.

A method according to the invention is also disclosed for manufacturing a blade for use in a blade assembly for a power trowel. Such a blade is made from unfinished sheet metal of trowel blade quality. Salient steps of the method include: cutting the unfinished sheet metal into blade shape, stabilizing a blade bar on a first surface of the blade, and laser welding the blade bar to the blade through a second surface of the blade that is opposite the first surface. The cutting step may be effected by laser cutting, and may employ the same laser-emitting device that is used to effect the laser welding step. The cutting step may include laser cutting an outer edge of the blade, and may further include forming the outer edge or a portion thereof as a full bullnose edge, a half-bullnose edge, or a demi-bullnose edge. The laser welding step may include welding along a path in parallel with a longitudinal center of the blade bar, and preferably includes welding through a bottom surface of the blade to secure the blade bar to a top surface of the blade.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. Dimensions shown are exemplary only. In the drawings, like reference numerals may designate like parts throughout the different views, wherein:

FIG. 1 is a top view of a first embodiment of a trowel blade assembly according to the present invention.

FIG. 2 is a cross-sectional side view, taken along line A-A, of the first embodiment of a trowel blade assembly.

FIG. 3 is a bottom view of the first embodiment of a trowel blade assembly.

FIG. 4 is a bottom view of an alternative embodiment of a trowel blade assembly according to the present invention.

FIG. 5 is a cross-sectional view, taken along line B-B, of one embodiment of a trowel blade assembly according to the present invention.

FIG. 6 is a cross-sectional view, similarly taken along line B-B, of an alternative embodiment of a trowel blade assembly according to the present invention.

FIG. 7 is a perspective view of an embodiment of a trowel blade assembly according to the present invention.

FIG. 8 is a magnified view, taken from the box marked in FIG. 7, of a first embodiment of an edge profile for a trowel blade assembly according to the present invention.

FIG. 9 is a magnified view, taken from the box marked in FIG. 7, of an alternative embodiment of an edge profile for a trowel blade assembly according to the present invention.

FIG. 10 is a flow chart diagramming the salient steps of a first embodiment of a method for manufacturing trowel blade assemblies according to the present invention.

### DETAILED DESCRIPTION OF THE INVENTION

The following disclosure presents exemplary embodiments for a novel trowel blade assembly and methods for manufacturing the same. The trowel blade assembly according to the present invention reduces manufacturing time and costs for each trowel blade while maintaining high structural integrity. It is estimated that the present invention may reduce trowel blade manufacturing costs by as much as 30% while also speeding up the manufacturing time per blade assembly. The novel trowel blade assembly according to the present invention eliminates the need for expensive and time consuming machining processes required to connect each blade to a blade bar, which provides the interface for connecting to the power trowel machine. Rather, the present invention provides a laser weld that is applied through a surface of the blade to secure the blade bar to the opposite surface. The laser welding operation takes a fraction of the time to secure the blade bar to the blade when compared with the traditional attachment methods. Further, the laser welding operation results in a very secured connection between the blade bar and the blade while minimizing or completely eliminating stress points that may damage the blade during operation of the power trowel.

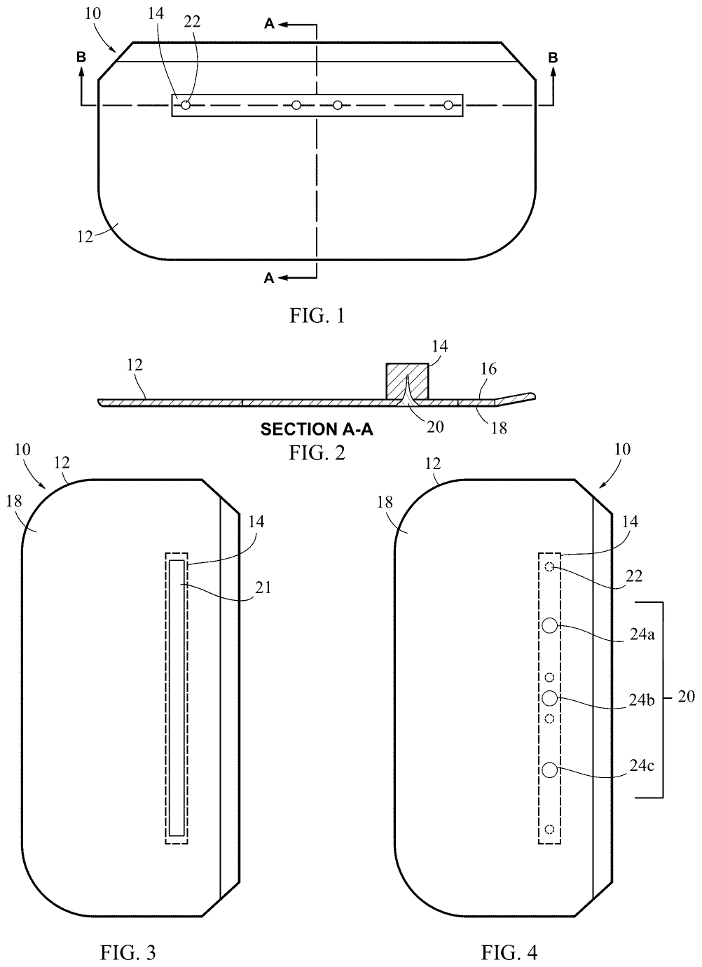

FIG. 1 is a top view of an embodiment of a trowel blade assembly according to the present invention. The trowel blade assembly 10 includes a blade 12 connected to a blade bar 14. The blade bar 14 provides the interface for connecting the trowel blade assembly 10 to a trowel arm extending from the power trowel machine, which may be, for example, a walk-behind or a ride-on trowel. Accordingly, the blade bar 14 preferably includes two or more screw holes 22 tapped into the bar and configured to secure the assembly 10 to the trowel arm of a power trowel machine. The trowel arm and power trowel machine have been excluded from the figures for the sake of simplicity and clarity.

FIG. 2 is a cross-sectional side view, taken along section lines A-A marked in FIG. 1, of a first embodiment of a trowel blade assembly according to the present invention. The blade 12 has a top surface 16 and a bottom surface 18. The blade bar 14 is attached to the top surface 16 by a laser weld 20 applied through the bottom surface 18. The laser weld 20 can be applied according to conventional laser welding techniques, such as keyhole laser welding, deep penetration laser welding, YAG (neodymium yttrium-aluminum garnet) laser welding or CO₂ laser welding. In preferred embodiments, the laser weld 20 is applied using conventional laser stir welding techniques, as will be detailed further below.

FIG. 3 is a bottom view of a first embodiment of the trowel blade assembly according to the present invention, the blade bar 14 being shown in phantom lines. In this embodiment, the laser weld 20 may be referred to as a laser weld 21, which is formed as a single, continuous weld segment applied through the bottom surface 18 along the longitudinal center of the blade bar 14.

FIG. 4 is a bottom view of an alternative embodiment of a trowel blade assembly according to the present invention, the blade bar and screw holes being shown in phantom lines. The trowel blade assembly 10 illustrated in FIG. 4 includes another more specific form of a laser weld 20, which consists of a plurality of non-continuous laser weld segments 24a, 24b, 24c. The non-continuous laser weld segments 24a, 24b and 24c combine to make up the laser weld 20 for securing the blade bar 14 to the blade 12. In preferred embodiments, each of the non-continuous laser weld segments 24a, 24b, 24c are formed between adjacent screw holes 22 defined in the blade bar 14. This configuration allows the screw holes 22 to be formed with the required depth in the blade bar 14 to ensure sufficient strength in the connection to the trowel arm.

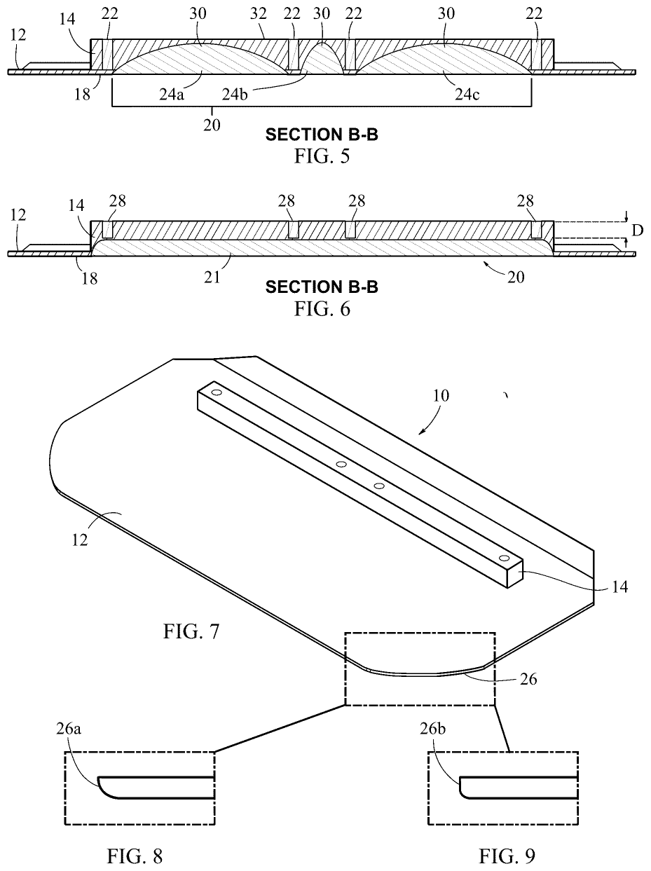

FIG. 5 is a cross-sectional view, taken along lines B-B marked in FIG. 1, of a first embodiment of a trowel blade assembly according to the present invention. The laser weld 20 includes a plurality of non-continuous laser weld segments 24a, 24b, and 24c applied between adjacent screw holes 22. In this embodiment, screw holes 22 extend through the entire thickness of the blade bar 14. Other embodiments are possible in which the screw holes 22 extend only part way through the thickness of the blade bar 14. In any case, the laser weld 20 does not interfere or otherwise obstruct the screw holes 22, thereby allowing for the trowel blade assembly 10 to be connected to the power trowel in conventional fashion, e.g., using threaded fasteners that engage screw holes 22 to bolt the blade bar 14 to a rotor assembly of the power trowel.

Each individual weld segment 24a, 24b, 24c may arc or curve upward from the bottom surface 18 toward a weld apex 30. The degree of curvature and the relative height from the bottom surface 18 to the apex 30 for each non-continuous weld segment 24a, 24b, 24c may be controlled by altering the welding time and the laser intensity used to apply each of the weld segments. For instance, in the embodiment illustrated by FIG. 5, non-continuous weld segments 24a and 24c may be created using a medium intensity laser, each applied over a ten-second window. The non-continuous weld segment 24b, in contrast, may be created using a high intensity laser applied over a five-second window. The higher intensity laser used to create weld segment 24b may be necessary to generate the steeper curve reaching to apex 30 when compared to weld segments 24a and 24c. The apex 30 may be coplanar with a top surface 32 of the blade bar 14 or, more preferably, slightly below the top surface 32 of the blade bar so there are no visible weld lines.

FIG. 6 is a cross-sectional view of an alternative embodiment of a trowel blade assembly of the present invention, similarly taken along line B-B marked in FIG. 1. In some embodiments, the blade bar 14 includes shallow screw holes 28, defined a fixed depth D into the thickness of the blade bar 14. The shallow screw holes 28 therefore do not extend through the entire thickness of the blade bar 14. A single, continuous laser weld segment 21 makes up the laser weld 20 and is applied through the bottom surface 18 of the blade 12 to weld the blade bar 14 thereto. The laser weld 21 may reach to, or near to, a bottom end of each shallow screw hole 28 but the laser weld 21 does not extend into or otherwise interfere with any of the shallow screw holes 28. The maximum depth of the single continuous laser weld segment 21 may therefore be said to be shallower than the maximum depth of each non-continuous laser weld segment 24a, 24b, 24c, where depth of the weld is defined as the distance the weld extends into the blade bar 14 from the bottom surface 18 of the blade 12. The depth of the single continuous laser weld segment 21 may be controlled by altering the weld time and the intensity of the laser used.

FIG. 7 is a perspective view of a trowel blade assembly 10 according to the present invention. FIGS. 8 and 9 are magnified views of a portion of an outer edge of the blade 12. Each of FIGS. 8 and 9 are magnified views of alternative embodiments of the edge portion of blade 12 identified by the dashed-line box in FIG. 7. The outer edge 26 of the blade 12 may be formed as a full bullnose edge, or may preferably be formed as a half-bullnose edge 26a (FIG. 8) or a demi-bullnose edge 26b (FIG. 9). As will be detailed further below with regard to the methods for manufacturing, forming the full bullnose edge, the half-bullnose edge 26a or the demi-bullnose edge 26b on the blade 12 using laser cutting techniques further reduces manufacturing time and costs per blade while increasing the efficiency of the blade 12 when installed and used with a power trowel machine.

In trowel blades formed using conventional techniques, the outer edge has a squared profile, resulting from the stamping process used to form the blade from the raw sheet metal material. This can result in the formation of sharp edges or burrs being present on the blade. Similarly, other traditional blades may not have a squared edge profile but instead have a generally curved or angled edge. A recurring problem with these blades is that the stamping process prevents the formation of a smooth tangent at the curved or angled edge. That is, a sharp burr or discontinuity in the curve or angle of the edge occurs as an artifact of the stamping process. In fact, the closer a manufacturer attempts to form a smooth tangent at the edge during stamping, the larger the burr that results. In conventional trowel blade manufacturing methods, prior to the blade being used for finishing concrete, the sharp edges or burrs need to be smoothed out, typically through a manual sanding or grinding operation, which increases the manufacturing costs per blade. The sharp edge or burrs must be removed for the blade to be effective at finishing concrete.

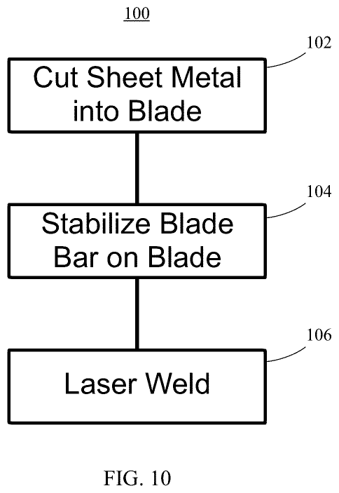

FIG. 10 is a flow chart diagramming salient steps for a method of manufacturing a trowel blade assembly according to the present invention. Method 100 begins with step 102 that involves cutting unfinished sheet metal into the form of a blade. Preferably, the unfinished sheet metal is high quality spring steel meeting conventional trowel blade specifications. The cutting step 102 may involve a conventional stamping process typically used in trowel blade manufacturing, e.g., using a hydraulic press to cut the blade from unfinished sheet metal stock. More preferably, however, according to the present invention, the cutting step 102 involves laser cutting the blade 12 from the unfinished sheet metal. The laser cutting step 102 can result in the formation of a full bullnose edge, a half-bullnose edge 26a, or a demi-bullnose edge 26b, depending on the requirements of the specific blade. Laser cutting the blade in step 102 may be accomplished using a YAG or CO₂ laser, either of which is effective at making precision cuts through steel with a thickness up 0.5 inches. YAG and CO₂ lasers are both known in the art and details on their use will not be provided for the sake of simplicity.

Once the blade 12 has been cut from the unfinished starting materials, the method 100 advances to step 104 where the blade bar 14 is stabilized on a first surface of the blade 12. Preferably, the blade bar 14 is stabilized on the top surface 16 of the blade 12. The method 100 thereafter advances to step 106 where the laser weld 20 is applied according to well-known laser welding techniques. In preferred embodiments, the laser used in the laser cutting step 102 is also used for the laser welding step 106, e.g., a YAG laser can be used for both cutting and welding. Preferably, the laser weld 20 is applied through a second surface of the blade that is opposite the first surface. In this example, the second surface is the bottom surface 18 of the blade 12. In alternative embodiments, the laser weld 20 may be applied in the opposite direction, through the top surface of the blade bar 14 and into the blade 12 through the top surface 16 thereof. Preferably, the laser weld 20 is applied through the bottom surface 18 along a weld line coinciding with the longitudinal center of the blade bar 14 positioned on the top surface 16. The laser weld 20 resulting from step 106 is therefore not visible when the trowel blade assembly 10 is connected to the power trowel machine. Depending on the blade bar 14 being secured, the laser welding step 106 may involve forming a single continuous laser weld segment 21 or a plurality of non-continuous laser weld segments, e.g., segments 24a, 24b, 24c. The depth of the laser weld 20 is controlled by the welding time and intensity of the laser used during the welding step 106. The type of laser weld 20 to be applied, i.e., a single continuous segment or multiple non-continuous segments, may be determined by the type of screw hole formed in the blade bar 14. Where the blade bar 14 includes multiple shallow screw holes 28, the single continuous weld segment 21 may be utilized in step 106. In contrast, where the blade bar 14 includes screw holes 22 that extend fully through the blade bar 14 thickness, a plurality of non-continuous weld segments 24a, 24b, 24c may be utilized in step 106.

Laser welding 106 the blade bar 14 to the blade 12 offers a quick and simple solution to ensuring a secured connection is created and maintained. In some embodiments, the laser welding step 106 may further involve the use of filler material during the welding process. Addition of the filler material may improve the relative strength of the laser weld 20. The filler material may be any known welding filler material, e.g., aluminum, nickel alloys, brass, copper, etc. It is preferred to use stick or wire forms of the filler material, although powdered formulations may also be used.

In some further embodiments of method 100, there may be an additional step 108 for finishing or polishing the laser weld 20 applied during step 106. The finishing step 108 may involve light sanding or grinding of the bottom surface 18 around the laser weld 20 to remove any sharp corners or protrusions that may have resulted from the laser welding process.

Method 100 provides numerous advantages over the conventional trowel blade manufacturing and assembly process now in use. The method 100 significantly reduces manufacturing time and costs per blade by eliminating numerous time consuming machining and finishing steps required in the conventional processes. Further, laser welding according to method 100 is highly repeatable and produces consistent laser welds 20 among each operation, leading to higher quality control for the trowel blade assembly 10 according to the present invention. By laser cutting in step 102 to form the blade 12 out of the unfinished sheet metal, the method 100 provides for the elimination of large and expensive mechanical presses needed to stamp blades according to existing practices, thereby reducing the manufacturing footprint. This also leads to the elimination of the maintenance department required for those large mechanical presses, further reducing the manufacturing costs per blade assembly.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A trowel blade assembly configured for use on a power trowel, comprising:
a blade having a top surface and a bottom surface; and
a blade bar positioned on the top surface, wherein the blade bar is attached to the blade by a laser weld applied along the bottom surface.

2. The trowel blade assembly of claim 1, wherein the laser weld comprises a plurality of non-continuous weld segments.

3. The trowel blade assembly of claim 2, wherein each of the non-continuous weld segments align in parallel to a longitudinal center of the blade bar.

4. The trowel blade assembly of claim 3, wherein the blade bar further comprises two or more screw holes defined in the blade bar and configured to engage a trowel arm of a power trowel.

5. The trowel blade assembly of claim 4, wherein each non-continuous weld segment lies between an adjacent pair of the two or more screw holes.

6. The trowel blade assembly of claim 1, wherein the laser weld is applied along a longitudinal center of the blade bar.

7. The trowel blade assembly of claim 1, wherein the laser weld is applied using a laser stir welding technique.

8. The trowel blade assembly of claim 1, further comprising filler material applied to the laser weld.

9. The trowel blade assembly of claim 1, wherein the laser weld extends through the bottom surface to weld a portion of the blade bar to the blade.

10. The trowel blade assembly of claim 1, wherein the blade comprises an outer half-bullnose lasered edge.

11. The trowel blade assembly of claim 1, wherein the blade comprises an outer demi-bullnose lasered edge.

12. The trowel blade assembly of claim 1, wherein the blade consists of high carbon spring steel.

13. The trowel blade assembly of claim 1, wherein a weld line formed by the laser weld is coplanar with the bottom surface of the blade.

14. A method for manufacturing a blade assembly for a power trowel from an unfinished sheet metal of trowel blade quality, comprising:
cutting the unfinished sheet metal into a blade;
stabilizing a blade bar on a first surface of the blade; and
laser welding the blade bar to the blade through a second surface of the blade that is opposite the first surface.

15. The method of claim 14, wherein the cutting step comprises laser cutting.

16. The method of claim 14, wherein the cutting step further comprises laser cutting an outer edge of the blade.

17. The method of claim 16, wherein the laser cut outer edge comprises a bullnose edge.

18. The method of claim 16, wherein the laser cut outer edge comprises a demi-bullnose edge.

19. The method of claim 14, wherein the laser welding step comprises welding along a longitudinal center of the blade bar.

20. The method of claim 19, wherein the laser welding comprises welding through a bottom surface of the blade to secure the blade bar to a top surface of the blade.
